(19) United States
(12) Patent Application Publication
(10) Pub. No.: US 2019/0384622 A1
(43) Pub. Date: Dec. 19, 2019

(54) PREDICTIVE APPLICATION FUNCTIONALITY SURFACING

(71) Applicant: Microsoft Technology Licensing, LLC, Redmond, WA (US)

(72) Inventors: Liang CHEN, Bellevue, WA (US); Michael Edward HARNISCH, Seattle, WA (US); Jose Alberto RODRIGUEZ, Seattle, WA (US); Steven Douglas DEMAR, Redmond, WA (US)

(21) Appl. No.: 16/008,909

(22) Filed: Jun. 14, 2018

(51) Int. Cl. G06F 9/451; G06F 3/0484; G06F 15/18; G06F 11/34; G06F 3/0482

(52) U.S. Cl. CPC G06F 9/453; G06F 3/0484; G06F 3/0482; G06F 11/3438; G06F 15/18

(57) ABSTRACT

In at least one implementation, the disclosed technology provides a method including tracking user activity in a set of associated application windows include inactive application windows and at least one active application window executing an active application and generating a prediction of one or more next functions based on the tracked user activity in the set of associated application windows. The one or more next functions are functions of the active application. The method further includes surfacing the one or more next functions by presenting one or more controls to the one or more next functions in a separate contextual tool window of the computing device and detecting user selection of a control of the one or more presented next functions. The method further includes executing the next function corresponding to the selected control in the active application in the set of associated application windows.

### CROSS REFERENCE TO RELATED APPLICATIONS

The present application is related to U.S. Patent Application [Docket No. 404361-US-NP], entitled “Inter-application Context Seeding”; U.S. patent application ______ [Docket No. 404363-US-NP], entitled “Next Operation Prediction for a Workflow”; and U.S. patent application ______ [Docket No. 404368-US-NP], entitled “Surfacing Application Functionality for an Object,” all of which are concurrently filed herewith and incorporated herein by reference for all that they disclose and teach.

### BACKGROUND

Many tasks in a user's workflow on computing systems are accomplished through the use of multiple applications across a set of associated application windows. User activity across the applications that are a part of the set of associated application windows may change depending on the task the user is attempting to complete. Further, in some situations, it may be useful to present the user with functionality of one or more of the applications to enhance or extend the user's workflow.

### SUMMARY

In at least one implementation, the disclosed technology provides for tracking user activity in a set of associated application windows include inactive application windows and at least one active application window executing an active application and generating a prediction of one or more next functions based on the tracked user activity in the set of associated application windows. The one or more next functions are functions of the active application. The one or more next functions are surfaced by presenting one or more controls to the one or more next functions in a contextual tool window of the computing device. User selection of a control of the one or more presented next functions is detected. The next function corresponding to the selected control is executed in the active application in the set of associated application windows.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example set of associated application windows and a contextual tool window providing predictive application functionality surfacing.

FIG. 2 illustrates an example set of associated application windows executing a function selected via a contextual tool window providing predictive application functionality surfacing.

FIG. 3 illustrates an example flow of operations for predictive application functionality surfacing.

FIG. 4 illustrates an example system for predictive application functionality surfacing.

FIG. 5 illustrates another example system for predictive application functionality surfacing.

FIG. 6 illustrates example operations for predictive application functionality surfacing.

FIG. 7 illustrates an example computing device that may be useful in implementing the described technology.

### DETAILED DESCRIPTIONS

Predictive application functionality surfacing surfaces functionality within an active application window during a given workflow. Surfacing the functionality of an active application may assist in providing a smoother workflow experience because a user spends less time navigating through the active application to find the desired functionality. Instead, predictive application functionality surfacing predicts what functionality the user may select based on the user's activity within a set of associated application windows including the active application.

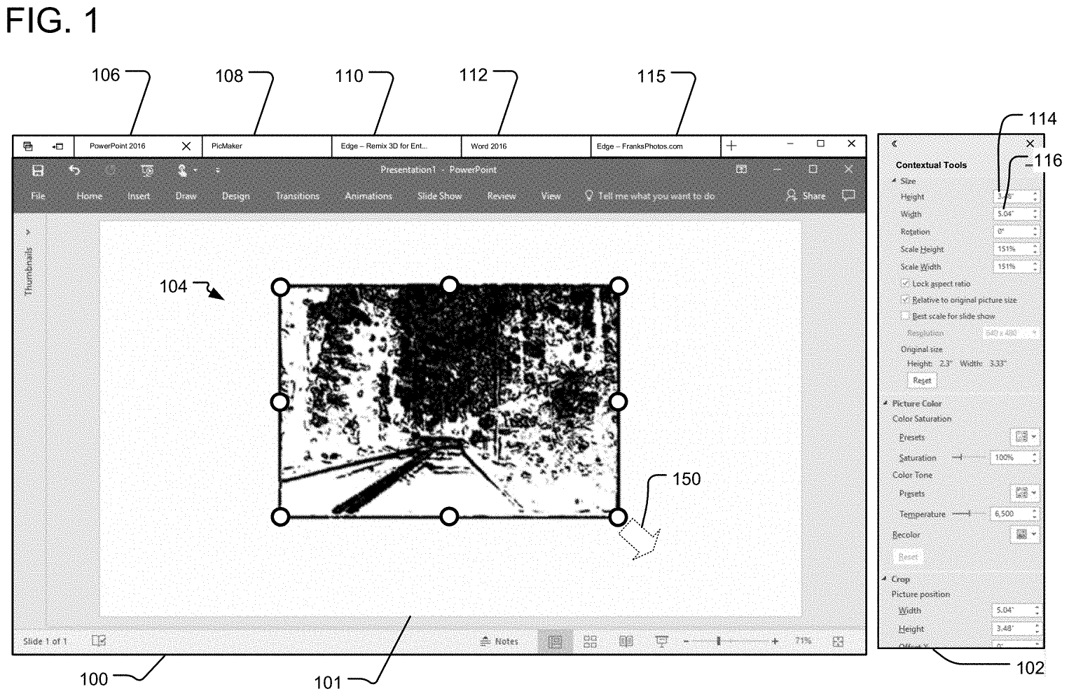

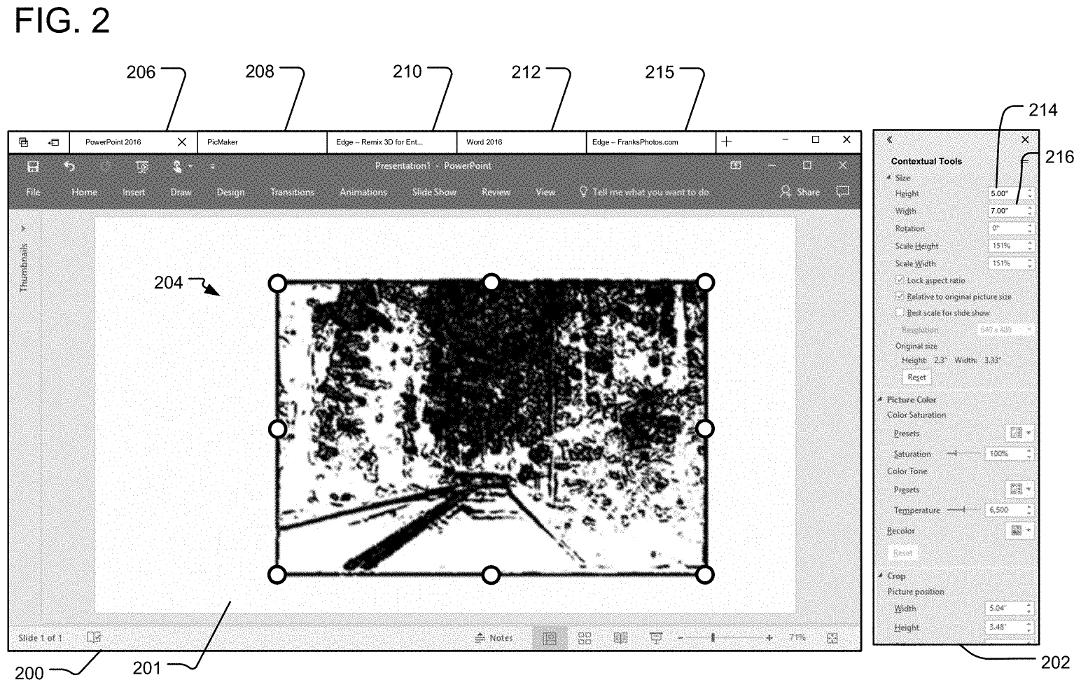

When working within a given workflow, a user may combine multiple applications into a set of associated application windows representing an organization of activities to support that workflow. For example, a user who is developing a presentation may be working with a set of associated application windows that includes a presentation application window, an image editor application window, an image gallery application window, and a word processing application. In this manner, the set of associated application windows may be displayed, stored, shared, and executed as a cohesive unit, such as in a tabbed set window, as shown in FIGS. 1 and 2, or some other user interface component providing functional and visual organization to such associated application windows. For example, in one implementation, these associated application windows may be presented in a “set window,” although in other implementations, the associated application windows may be displayed in separate application windows. The association of the application windows may be designated by a user, by shared properties or content, or by operating system facilities. For example, in one implementation, the set of associated application windows may be associated through shared assignment to a virtual desktop or other environment.

The described technology is provided in an environment in which a set of associated application windows are grouped in an association or set to interact and coordinate content and functionality among the associated application windows, allowing a user or the operating system to more easily track their tasks and activities, including tracking content interactions through interaction representations, in one or more computing systems in a set window of the associated application windows. An interaction representation is a structured collection of properties that can be used to describe, and optionally visualize or activate, a unit of user-engagement with discrete content using a computing system or device, including a particular application window used to access the content. The content can be internal content to one or more applications (e.g., an image editing application) or external content (e.g., images from an image gallery website accessible by a browser application). In some implementations, the application and/or content may be identified by a URI (Universal Resource Identifier).

As will be described in more detail, the described technology relates to predictive surfacing of application functionality of an active application within a set of associated application windows. The active application is the selected application of the set of associated application windows. In some implementations, more than one application may be active at one time. Application functionality of the active application is any function or command available within the active application. In some implementations, all functions of the active application may be available for predictive surfacing. In other implementations, a subset of functions of the active application are available for predictive surfacing.

Predictive surfacing of application functionality presents controls corresponding to an application function in a separate contextual tool window separate from the active application. An application function may be any capability of the application traditionally accessible to the user through menus, toolbars, or other controls within the active application executing in the active application window. Predictive surfacing of application functionality allows the user to more easily access controls for application functionality through the separate contextual tool window instead of directly through the active application window. A control corresponding to functionality of an application may be any type of object that a user interacts with to control a function of an application. The control presented in the contextual tool window may have a different appearance than a control accessible in the application for the same function.

The separate contextual tool window is executed by a separate processing thread than that of the active application window and yet displays functionality (e.g., a next available function) of the active application. The contextual tool window may be a modal or non-modal control window for the active application. The presented controls correspond to one or more predicted next functions based on user activity. For example, when a user highlights text in a word processing application, predictive surfacing of application functionality may predict that the next function will be to italicize the text or to bold the text. Controls for italicizing the text and bolding the text may be presented in the contextual tool window. In one implementation, user activity may be tracked over time to aid in predicting the next function. For example, if a user frequently highlights text and then selects the option to underline the text within the word processing application, a control to underline the text may be presented in the contextual tool window when the user highlights text.

Further, user activity may be tracked across applications and predictions may be based on the applications with which the user is interacting. For example, image filter functionality may be surfaced when a user pastes an image into a presentation editing application from an image gallery application. However, the image filter functionality may not be surfaced when a user pastes the same image into the presentation editing application from a photo editing application.

The predictive surfacing of application functionality occurs through machine learning. A machine learning module may initially make predictions based on generic preferences. Over time, the machine learning module may make predictions based on the functions a user typically selects after a specific user activity or series of user activities. Predictive surfacing of application functionality may occur in a variety of computing environments including, without limitation, traditional operating systems, mobile computing environments, and virtual reality (VR) environments.

FIG. 1 illustrates an example set of associated application windows and a contextual tool window 102 providing predictive application functionality surfacing. As shown in FIG. 1, the set of associated application windows form a set window 100. The contextual tool window 102 provides access to functions of the applications within the set window 100.

An active application window 106 is a presentation editing application (such as PowerPoint®) within the set window 100. In the illustrated example, a user has pasted an image 104 onto a presentation slide 101. The set window 100 includes inactive applications 108, 110, 112, and 115. The presentation slide 101 is indicated by a tab corresponding to the active application 106, and four hidden application windows are indicated by tabs corresponding to the inactive applications 108, 110, 112, and 115. The user can switch to any of the hidden application windows of the set window 100 by selecting one of the tabs or employing another window navigation control. It should be understood that individual application windows may be “detached” from the set window (e.g., removed from the displayed boundaries of the set window) and yet remain “in the set window” as members of the associated application windows of the set window.

Predictive application functionality surfacing can surface functionality from the active application window 106 based on the user's activity within the set window 100. The user's activity within the set window 100 may include activity in the active application window 106 or previous activity in the inactive tabs 108, 110, 112, and 115. For example, in the illustrated example, a user has pasted the image 104 onto the presentation slide 101. As a result, image editing functionality from the active application window is surfaced, and controls for the surfaced image editing functionality are displayed on the contextual tool window 102. For example, a height adjustment control 114 and a width adjustment control 116 are displayed on the contextual tool window 102.

The prediction of which functionality to surface may be based at first on controls that a typical user may select when engaging in a certain user activity. Over time, the prediction may be further based on the controls that a specific user selects when engaging in a certain user activity. For example, the height adjustment control 114 and the width adjustment control 116 may not be surfaced when a typical user pastes the image 104 onto the presentation slide 101 (or may be surfaced on a less prominent area of the contextual tool window 102). However, if a specific user continually uses the height adjustment control 114 and the width adjustment control immediately after pasting the image 104 onto the presentation slide 101, the height adjustment control 114 and the width adjustment control 116 may be surfaced and displayed at a prominent position on the contextual tool window 102 for the specific user.

In some implementations, user activity may include a history of user activity within the set window 100. For example, the user activity may include which inactive applications 108, 110, 112, and 115 are open with the active application 106. The user activity may also include user activity within the inactive application 108, 110, 112, and 115 immediately preceding the user activity within the active application 106. For example, the functionality surfaced in the contextual tool window 102 may be different when the user copied the image 104 from a word processing application than when the user copied the image 104 after editing the image in an image editing application.

The predicted surface-able functionality may be chosen from a set of surface-able functionality identified by the active application 106 during a registration operation. In some implementations, the applications executing in the application windows 108, 110, 112, and 115 also register functionality during the registration operation. Registration occurs when the active application 106 communicates what functions of the application are surface-able. In some implementations, the active application 106 communicates a set of globally unique identifiers (GUIDs) to a functionality surfacing datastore. Each of the communicated GUIDs represents a surface-able function of the active application 106 and may be used to call a library to create a user interface (UI) and an object for a function when the function is surfaced. In another implementation, registration occurs when the active application 106 directly communicates objects and UI corresponding to each surface-able function of the active application 106 to the functionality surfacing datastore.

Controls associated with the predicted surface-able functionality are presented in the contextual tool window 102 separate from the set window 100 and the active application 106. For example, in FIG. 1, controls for changing the size of the image 104, changing the color of the image 104, and cropping the image 104 are presented in the contextual tool window 102. The controls are presented using the UIs received during the registration of the active application 106 corresponding to the predicted surface-able functionality. The UIs may be specially formatted for the contextual tool window 102 or may be similar to UIs within the active application 106. In the example shown in FIG. 1, the dotted-line arrow 150 indicates a direction of a size adjustment that can be made through the contextual tool window 102 on the image 104.

FIG. 2 illustrates an example set of associated application windows executing a function selected via a contextual tool window 202 providing predictive application functionality surfacing. The set of associated application windows is a set window 200. The set window 200 includes an active application 206 and inactive applications 208, 210, 212, and 215. Previously, controls corresponding to predicted surface-able functionality were presented in the contextual tool window 202 after an image 204 was pasted onto a presentation slide 201. After the controls are presented in the contextual tool window 202, user selection of the controls is detected.

A height adjustment control 214 and a width adjustment control 216 are presented in the contextual tool window 202. As shown in FIG. 2, the user has selected and interacted with the height adjustment control 214 and the width adjustment control 216 to adjust the size of the image 204 on the presentation slide 201. The user's interaction with the height adjustment control 214 and the width adjustment control 216 is detected. In some implementations, the user may interact multiple times with a single control. For example, the user may use the arrows that are part of the height adjustment control 214 to adjust the size of the image 204 several times. After selection of or interaction with the height adjustment control 214 and the width adjustment control 216 are detected, the active application 206 executes the functions corresponding to the height adjustment control 214 and the width adjustment control 216. In some implementations, further functions may be surfaced based on the controls selected by the user.

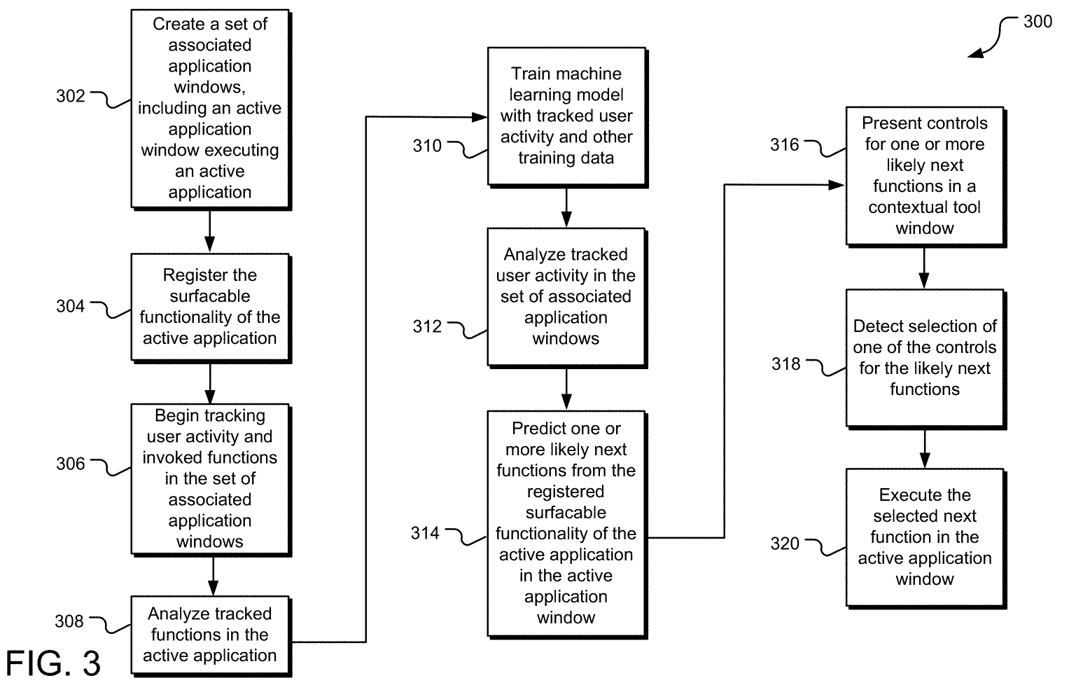

FIG. 3 illustrates an example flow of operations for predictive application functionality surfacing. A creation operation 302 creates a set of associated application windows with one or more associated application windows. The set of associated application windows includes an active application window executing an active application and may include one or more inactive application windows. A registration operation 304 registers the surface-able functionality of the applications executing in the associated application windows. In one implementation, registration of the surface-able functionality occurs when the active application communicates with a functionality register. The active application communicates surface-able functionality and the user interface (UI) for controls for the surface-able functionality to the functionality register. For example, the active application may communicate a GUID to the functionality register. The functionality register may use the communicated GUID to identify the surface-able functionality. The functionality register may maintain a list of surface able functionality for each application in the set of associated application windows.

A tracking operation 306 tracks user activity in the set of associated application windows. The user activity may be, for example, which of the associated windows is the active application window, mouse clicks within the set of associated application windows, and keystrokes within the set of associated application windows. The tracking operation 306 may also track the order of user activity or the order of use of the associated application windows.

An analyzing operation 308 tracks historical “next” functions invoked by the user and/or other users during the same or similar user activity. As such, the historical “next” functions invoked by users constitute “labels” associated with the “observations,” the user activity. Other information may also be analyzed as context (e.g., observations) in the analyzing operation 308 including without limitation the identity of the active application, the identity of the inactive application, the time of day the user activity occurs, previous user activity, the network to which the user is connected, the user's location, and the computing interface on which the user activity occurs (e.g., a mobile device, a desktop system, a remote desktop, and a mixed/virtual reality interface). All of these factors may be collected to define a context from which a functionality surfacing system can predict appropriate function user interfaces to present to the user through the contextual tool window. A training operation 310 inputs the tracked “next” functions and other training data, such as user activity, the identity of the active application, and other contextual information, in one implementation, into a machine learning model to train the model. In a machine learning environment, a context in the training operation 310 acts as a labeled observation, where the tracked “next” functions act as the corresponding labels. The analyzing operation 308 and the training operation 310 can loop as new training data becomes available. In some implementation, predictions in a prediction operation 314 may not employ such analysis and training operations, but they are described herein as examples.

An analyzing operation 312 analyzes tracked user activity in the set of associated application windows. The analyzing operation 312 may use the machine learning model trained in the training operation 310 to analyze the tracked user activity in the set of associated application windows.

A prediction operation 314 predicts one or more likely next functions from the registered surface-able functionality of the active application in the active application window. The prediction operation 314 may predict the one or more likely next functions from the registered surface-able functionality of the active application.

A presenting operation 316 presents controls for one or more likely next functions in a contextual tool window. The UI for controls is received during the registration operation 304. In some implementations, the presenting operation 316 may further determine how to present the controls in the contextual tool window. For example, the presenting operation 316 may also filter, re-rank or modify the selected predicted functions. For example, if the machine learning model output ten highest-ranked functions, the contextual tool controller may determine that one of the functions cannot be displayed in the contextual tool window of the current computing device display (e.g., not enough display real estate) or cannot/should not be executed on the current computing device (e.g., the function requires pen input, and the computing device does not support pen input). In another example, the contextual tool controller may re-rank the presented functions, such as when a resource (e.g., a camera) for a function is not yet available—re-ranking can be dynamic so that the function becomes more highly ranked when the resource becomes available.

A detection operation 318 detects selection of one of the controls of the likely next functions. In some implementations, the detection operation 318 detects initial selection of a control. For example, a control to apply a filter to an image may require one selection from the user. In other implementations, the detection operation 318 may include detecting an initial selection of a control and detecting additional user input. For example, a control to crop an image may require that the user selects the control and then types input to specify the size of the cropped image. Responsive to the detection operation 318, an execution operation 320 executes the selected next function in the active application window.

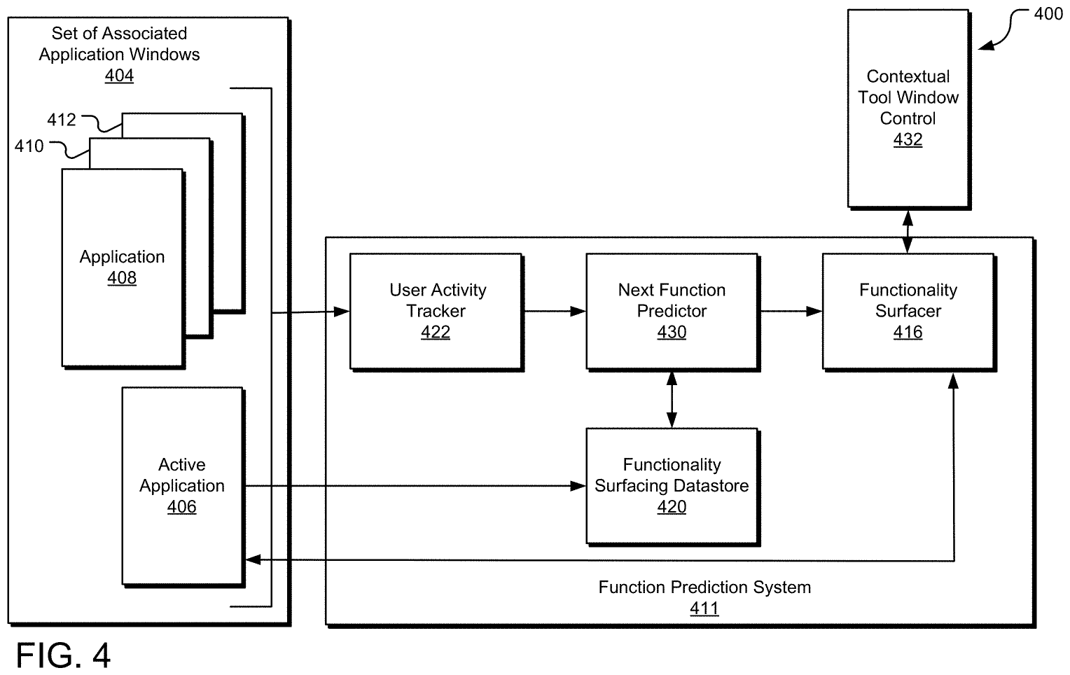

FIG. 4 illustrates an example system for predictive application functionality surfacing. A function prediction system 411 includes a user activity tracker 422, a next function predictor 430, a functionality surfacer 416, and a functionality surfacing datastore 420. The function prediction system 411 works with a set of associated application windows 404 to predict which functions of an active application 406 to surface in a contextual tool window control 432. The set of associated application windows 404 also includes applications 408, 410, and 412.

To predict which functions of the active application 406 to surface in the contextual tool window control 432, the user activity tracker 422 tracks user activity within the set of associated application windows 404. The activity tracker 422 may track user activity within the active application 406 and other applications 408, 410, and 412 within the set of associated application windows 404. User activity may include any user interaction with the active application 406 or the other applications 408, 410, and 412 within the set of associated application windows 404. The user activity tracker 422 may track user data by, for example, monitoring function calls or monitoring function metadata. In some implementations, the tracked user activity may be aggregated user activity of other users within an identical or similar set of associated application windows 404.

The active application 406 registers with the functionality surfacing datastore 420. In some implementations, the active application 406 communicates a set of globally unique identifiers (GUIDs) to a functionality surfacing datastore 420. Each of the communicated GUIDs represents a surface-able function of the active application 406 and may be used to call a library to create a user interface (UI) and an object for a function when the function is surfaced. In another implementation, registration occurs when the active application 406 directly communicates objects and UI corresponding to each surface-able function of the active application 406 to the functionality surfacing datastore 420.

The next function predictor 430 receives surface-able functionality from the functionality surfacing datastore 420 and the tracked user activity from the user activity tracker 422. The next function predictor 430 uses the tracked user activity to predict the next function to surface from the subset of surface-able functionality for the active application 406 received from the functionality surfacing datastore 420. In some implementations, the next function predictor 430 includes a machine learning module. The next function predictor 430 may be given initial conditions for predicting the next function. Alternatively, the next function predictor 430 may be trained with a training set of user activity to predict the next function. Over time, the machine learning module of the next function predictor 430 can better predict the preferences of a particular user. For example, if a particular user consistently adjusts the size of an image after pasting the image into a presentation editing application, the next function predictor 430 will consistently surface size adjustment functionality when an image is pasted into a presentation editing application.

The next function predictor 430 passes the predicted next function and its associated UI to the functionality surfacer 416. In some implementations, the functionality surfacer 416 uses a GUID communicated by the active application 406 during registration to access a library of the active application 406 that provides the programming methods and data for the predicted next function. In other implementations, the functionality surfacer 416 may directly receive the next function and its UI. The functionality surfacer 416 communicates with the contextual tool window control 432 to display the UI for the next function for the active application 406 in a contextual tool window. The contextual tool window control 432 detects when the user has selected one of the displayed UIs and passes the detection and any user selections to the functionality surfacer 416. The functionality surfacer 416 communicates the user selections to the active application 406, and the active application 406 executes the corresponding function in the window of the active application 406.

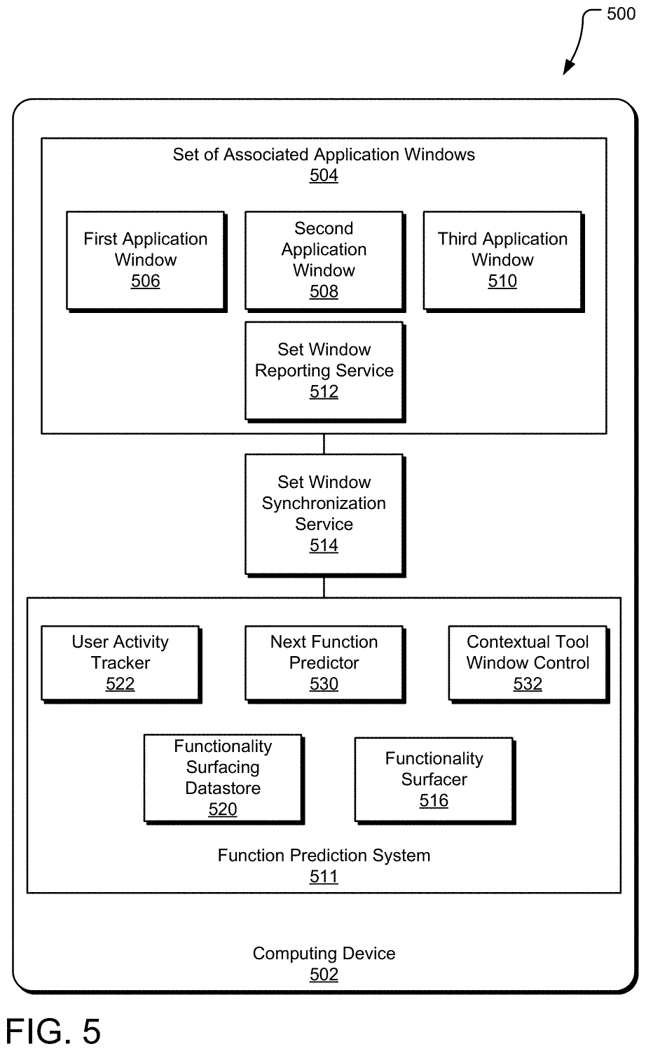

FIG. 5 illustrates another example system for predictive application functionality surfacing. In the example shown in FIG. 5, a set of associated application windows 504 acts as a set window. A computing device 502 includes an associated windows synchronization service 514, which manages the set of associated application windows 504, including, for example, a first application window 506, a second application window 508, and a third application window 510. A set window reporting service 512 can collect information reported by the application windows 506, 508, and 510, such as through an interface, and send the information to a set window synchronization service 514 of the computing device 502 (or any other computing device that hosts a set window synchronization service).

The computing device 502 can be connected through a communications network or cloud (e.g., being connected through an internet, an intranet, another network, or a combination of networks). In some cases, the set window reporting service 512 can also send information to other computing devices. The set window reporting service 512 can allow applications to make various calls to an interface, such as an interface that provides for the creation or modification of information regarding interaction representations, including information stored in one or more of task records, activity records, and history records.

The set window synchronization service 514 can collect interaction information and user activity from one or more of the computing devices. The collected information may be used to update interaction representations or user activity stored on one or more of the computing devices. For example, the computing devices may represent mobile devices, such as smartphones or tablet computers. A computing device may represent a desktop or laptop computer. In this scenario, the set window synchronization service 514 can send information regarding the mobile devices (e.g., interaction representations or user activity) to the desktop/laptop, so that a user of the desktop/laptop can be presented with a comprehensive view of user activity across all the computing devices. In other scenarios, the computing devices may also be sent information regarding user activity on other computing devices.

The set window synchronization service 514 can carry out other activities. For instance, the set window synchronization service 514 can supplement or augment data sent by one computing device, including with information sent by another computing device. In some cases, the aggregation/synchronization component can associate history records for an activity carried out on one computing device with a task having another activity carried out using another of the computing devices.

The set window synchronization service 514 can also resolve conflicts between data received from different computing devices. For instance, conflicts can be resolved using a rule that prioritizes interaction representations or user activity from different devices, prioritizes interaction representations or user activity when the user activity was generated, prioritizes interaction representations or user activity on a reporting source, such as a particular application or a shell monitor component, such as if two computer devices include user activity for the same activity at overlapping time periods.

For example, if a user was listening to music on two computer devices, the playback position in the same content may differ between the devices. The set window synchronization service 514 can determine the appropriate playback position to associate with the activity. Thus, set window synchronization service 514 can determine “true” data for an interaction representation or user activity, and can send this information to one or more of the computing devices, including a computing device on which the activity was not carried out, or updating data at a device where the activity was carried out with the “true” data.

In particular implementations, information from interaction representations and user activity can be shared between different users. Each user can have an account in the computing device, such as stored in a database. Records for interaction representations and user activities (including history records therefor) can be stored in the database in association with an account for each user. When information for an interaction representation or user activity is received and is to be shared with one or more other users, the shared information can be stored in the accounts for the other users, such as using collaborator identifiers.

The distribution of information between different user accounts can be mediated by the set window synchronization service 514. In addition to distributing information to different accounts, the set window synchronization service 514 can translate or format the information between different accounts. For instance, certain properties (e.g., applications used for various types of files, file paths, account information, etc.) of user activities may be specific to a user or specific devices of the user. Fields of the various records can be replaced or updated with appropriate information for a different user. Accordingly, a user account can be associated with translation rules (or mappings) defining how various fields should be adapted for the user.

The set window synchronization service 514 can also synchronize data needed to use any records received from another user, or from another device of the same user. For instance, records shared with a user may require an application or content not present on the user's device. The aggregation/synchronization component can determine, for example, whether a user's computing device has an appropriate application installed to open content associated with an interaction representation. If the application is not present, the application can be downloaded and installed for the user, or the user can be prompted to download and install the application. If the content needed for a record is not present on the user's computing device, the content can be sent to the user's computing device along with the record, or the user can be prompted to download the content. In other examples, interaction representations can be analyzed by a receiving computer device, and any missing content or software applications downloaded or installed (or other action taken, such as prompting a user to download content or install applications) by the receiving computer device.

A functionality surfacing datastore 520 represents a storage object in which surface-able functionality may be stored for applications executing in the application windows 506, 508, and 510. In some implementations, surface-able functionality may be stored as a list of GUIDs corresponding to surface-able functionality. The GUIDs may provide an entry point to a library in the application. Alternatively, surface-able functionality and corresponding UIs may be stored directly for applications executing in the application windows 506, 508, and 510.

A user activity tracker 522 tracks user activity within the application windows 506, 508, and 510 of the set of associated application windows 504. In one implementation, the user activity tracker 522 receives information about user activity from the set window reporting service 512. A next function predictor 530 predicts the next function based on user activity tracked by the user activity tracker 522. The next function predictor 530 may use a machine learning module to predict the appropriate functionality from the subset of surface-able functionality stored in the functionality surfacing datastore 520.

The next function predictor 530 communicates the predicted next function to a functionality surfacer 516. In some implementations, the next function predictor 530 also communicates the GUID corresponding to the predicted next function. The functionality surfacer 516 may then use the GUID to call a library to create a user interface (UI) and an object for a function when the function is surfaced. Alternatively, the next function predictor 530 may directly communicate the UI and a function object to the functionality surfacer 516.

The functionality surfacer 516 communicates the predicted next function (in the form of an object) and its corresponding UI to a contextual tool window control 532 for display on a user interface separate from the set of associated application windows 504.

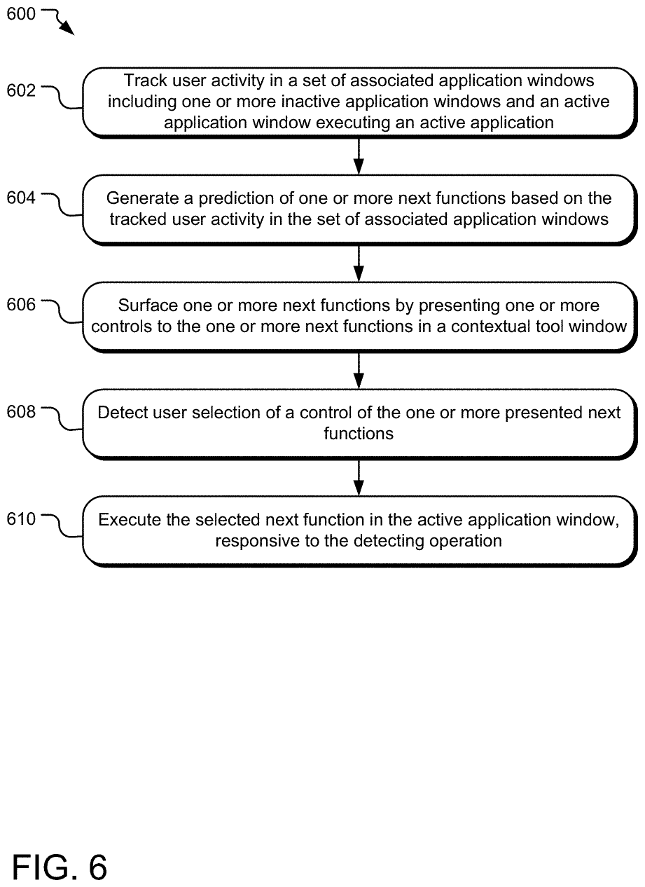

FIG. 6 illustrates example operations 600 for predictive application functionality surfacing. A tracking operation 602 tracks user activity in a set of associated application windows including one or more inactive application windows and an active application window executing an active application. The tracked user activity may include, without limitation, user activity in the active application window, user activity in the inactive application windows, the identity of the active application, the type of content in the active application window, and previous user activity. In some implementations, the tracking operation 602 further includes registration of the active application. Registration of the active application may include providing a list of surface-able functionality of the active application along with the corresponding UI for the surface-able functionality of the active application.

A generating operation 604 generates a prediction of one or more next functions based on the tracked user activity in the set of associated application windows. The generating operation 604 uses a machine learning subsystem (employing a machine learning model) to predict one or more next functions. The one or more next functions may be any function of the active application. In some implementations, the one or more next functions may be chosen from a subset of registered surface-able functions of the active application.

A surfacing operation 606 surfaces one or more next functions by presenting one or more controls corresponding to the one or more next functions in a contextual tool window. The controls corresponding to the one or more next functions may be stored in memory or may be received as a result of registration of the active application during the tracking operation 602. The surfacing operation 606 may present controls that are specifically formatted for the contextual tool window. In some implementations, the surfacing operation 606 may also determine the layout of the controls on the contextual tool window. For example, where more than one next function is surfaced, the surfacing operation 606 may determine the layout of multiple controls on the contextual tool window. The layout of the multiple controls on the user interface may be based, for example, on spatial considerations or on the probability that the user will use one control over another.

A detecting operation 608 detects user selection of a control corresponding to one of the surfaced next functions. The user selects a control corresponding to one of the surfaced next functions that has been surfaced on a contextual tool window. An executing operation 610 executes the selected next function in the active application window, responsive to the detecting operation 608.

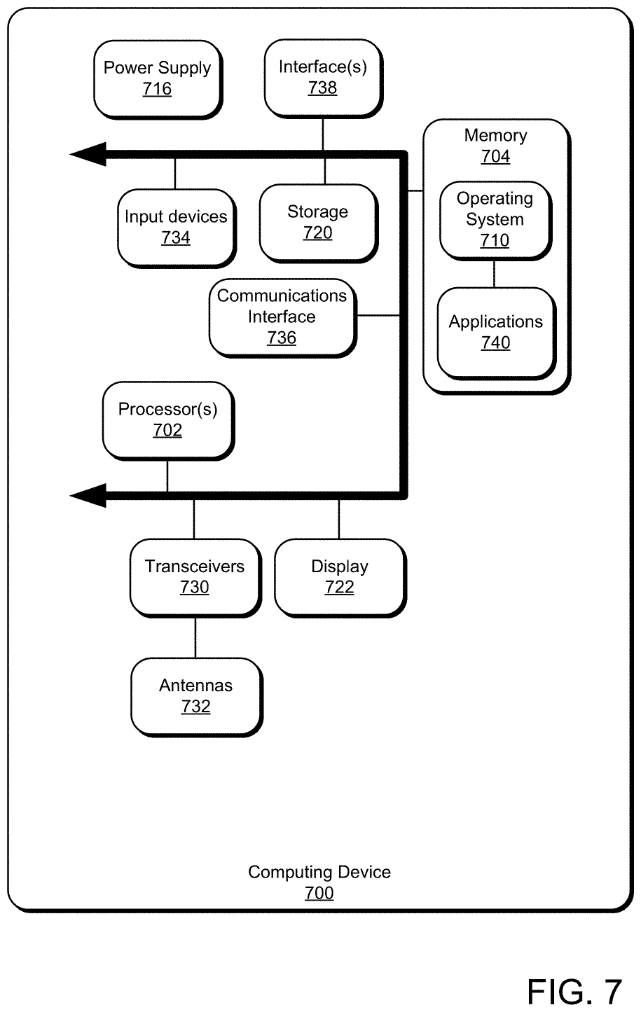

FIG. 7 illustrates an example computing device 700 that may be useful in implementing the described technology. The example computing device 700 may be used to provide predictive application functionality surfacing. The computing device 700 may be a personal or enterprise computing device, such as a laptop, mobile device, desktop, tablet, or a server/cloud computing device. The computing device 700 includes one or more processor(s) 702, and a memory 704. The memory 704 generally includes both volatile memory (e.g., RAM) and non-volatile memory (e.g., flash memory). An operating system 710 and one or more applications 740 reside in the memory 804 and are executed by the processor(s) 702.

One or more modules or segments, such as a user activity tracker, a next function predictor, a functionality register, a functionality surfacer, and other components are loaded into the operating system 710 on the memory 704 and/or storage 720 and executed by the processor(s) 702. Data such as user preferences, contextual content, contexts, queries, and other input, set window parameters, interactive representation and other data and objects may be stored in the memory 704 or storage 720 and may be retrievable by the processor(s). The storage 720 may be local to the computing device 700 or may be remote and communicatively connected to the computing device 700.

The computing device 700 includes a power supply 716, which is powered by one or more batteries or other power sources and which provides power to other components of the computing device 700. The power supply 716 may also be connected to an external power source that overrides or recharges the built-in batteries or other power sources.

The computing device 700 may include one or more communication transceivers 730 which may be connected to one or more antenna(s) 732 to provide network connectivity (e.g., mobile phone network, Wi-Fi®, Bluetooth®) to one or more other servers and/or client devices (e.g., mobile devices, desktop computers, or laptop computers). The computing device 700 may further include a network adapter 736, which is a type of communication device. The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard or mouse). These and other input devices may be coupled to the server by one or more interfaces 738 such as a serial port interface, parallel port, or universal serial bus (USB). The computing device 700 may further include a display 722 such as a touchscreen display.

The computing device 700 may include a variety of tangible processor-readable storage media and intangible processor-readable communication signals. Tangible processor-readable storage can be embodied by any available media that can be accessed by the computing device 700 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

An example method of predicting a next function in a set of associated application windows of a computing device having a contextual tool window is provided. The method includes tracking user activity in a set of associated application windows including one or more inactive application windows and an active application window executing an active application. The method also includes generating a prediction of one or more next functions based on the tracked user activity in the set of associated application windows. The one or more next functions are functions of the active application executing in the active application window. The method also includes surfacing the one or more predicted next functions by presenting one or more controls corresponding to the one or more next functions of the active application in the contextual tool window of the computing device, where each control is capable of executing the corresponding next function in the active application. The method further includes detecting user selection of a control of the one or more presented next functions in the contextual tool window, responsive to the surfacing operation and executing in the active application window the next function corresponding to the selected control, responsive to the detecting operation.

A method of any previous method is provided, where the method further includes registering surface-able functionality of the active application.

A method of any previous method is provided, where registering the surface-able functionality of the active application includes communicating one or more surface-able functionalities of the active application and one or more user interfaces corresponding to the one or more surface-able functionalities.

A method of any previous method is provided, where the prediction of one or more next functions is predicted from the registered surface-able functionality of the active application.

A method of any previous method is provided, where the prediction of one or more next functions is predicted further based on past tracked user activity.

A method of any previous method is provided, where the one or more next functions are predicted using machine learning.

A method of any previous method is provided, where the method further includes detecting user input to the control of the one or more presented next functions, responsive to detecting user selection of the control.

A method of any previous method is provided, where the method further includes storing an identity of the control of the one or more presented next functions selected by the user, responsive to detecting user selection of the control.

An example system for predicting a next function in a set of associated application windows of a computing device having a contextual tool window includes means for tracking user activity in a set of associated application windows including one or more inactive application windows and an active application window executing an active application. The system also includes means for generating a prediction of one or more next functions based on the tracked user activity in the set of associated application windows. The one or more next functions are functions of the active application executing in the active application window. The system also includes means for surfacing the one or more predicted next functions by presenting one or more controls corresponding to the one or more next functions of the application in the contextual tool window of the computing device. Each control is capable of executing the corresponding next function in the active application. The system also includes means for detecting user selection of a control of the one or more presented next functions in the contextual tool window, responsive to the surfacing operation and executing in the active application window the next function corresponding to the selected control, responsive to the surfacing operation.

An example system of any previous system further includes means for registering surface-able functionality of the active application.

An example system of any previous system is provided, where registering the surface-able functionality of the active application further includes communicating one or more surface-able functionalities of the active application and one or more user interfaces corresponding to the one or more surface-able functionalities.

An example system of any previous system is provided, where the prediction of one or more next functions is predicted from the registered surface-able functionality of the active application.

An example system of any previous system is provided, where the one or more next functions are predicted using machine learning.

An example system of any previous system further includes means for detecting user input to the control of the one or more presented next functions, responsive to detecting user selection of the control.

An example system of any previous system further includes means for storing an identity of the control of the one or more presented next functions selected by the user, responsive to detecting user selection of the control.

An example system for predicting a next function in a set of associated application windows of a computing device having a contextual tool window includes one or more processors and a user activity tracker executed by the one or more processors and configured to track user activity in a set of associated application windows including one or more inactive application windows and an active application window executing an active application. The system also includes a next function predictor executed by the one or more processors and configured to generate a prediction of one or more next functions based on the tracked user activity in the set of associated application windows. The one or more next functions are functions of the active application executing in the active application window. The system also includes a functionality surfacer executed by the one or more processors and configured to surface the one or more next functions by presenting one or more controls corresponding to the one or more next functions of the active application in the contextual tool window of the computing device. Each control is capable of executing the corresponding next function in the active application. The system also includes a contextual tool window control executed by the one or more processors and configured to detect user selection of a control of the one or more presented next functions in the contextual tool window, responsive to the surfacing of the one or more next functions and an associated windows synchronization service executed by the one or more processors and configured to execute in the active application window the next function corresponding to the selected control in the active application window, responsive to detection of the user selection.

An example system of any previous system further includes a functionality surfacing datastore configured to register surface-able functionality of the active application.

An example system of any previous system is presented, where the functionality surfacing datastore is configured to register the surface-able functionality of the active application by receiving one or more surface-able functionalities of the active application and one or more user interfaces corresponding to the one or more surface-able functionalities.

An example system of any previous system is presented, where the next function predictor is further configured to generate the prediction of one or more next functions from the registered surface-able functionality of the active application.

An example system of any previous system is presented, where the next function predictor is further configured to generate the prediction of one or more next functions further based on past tracked user activity.

An example system of any previous system is presented, where the next function predictor is further configured to generate the prediction of one or more next functions using machine learning.

Example one or more tangible processor-readable storage media are embodied with instructions for executing on one or more processors and circuits of a computing device a process of predicting a next function in a set of associated application windows of a computing device having a contextual tool window. The process includes tracking user activity in a set of associated application windows including one or more inactive application windows and an active application window executing an active application. The process also includes generating a prediction of one or more next functions based on the tracked user activity in the set of associated application windows. The one or more next functions are functions of the active application executing in the active application window. The process also includes surfacing the one or more predicted next functions by presenting one or more controls corresponding to the one or more next functions of the active application in the contextual tool window of the computing device. Each control is capable of executing the corresponding next function in the active application. The process also includes detecting user selection of a control of the one or more presented next functions in the contextual tool window, responsive to the surfacing operation and executing in the active application window the next function corresponding to the selected control in the active application window, responsive to the detecting operation.

Another example one or more tangible processor-readable storage media are embodied with instructions for executing on one or more processors and circuits of a device a process of any preceding process, further including registering a surface-able functionality of the active application.

Another example one or more tangible processor-readable storage media are embodied with instructions for executing on one or more processors and circuits of a device a process of any preceding process where the registering operation further includes communicating one or more surface-able functionalities of the active application and one or more user interfaces corresponding to the one or more surface-able functionalities.

Another example one or more tangible processor-readable storage media are embodied with instructions for executing on one or more processors and circuits of a device a process of any preceding process where the prediction of one or more next functions is generated from the registered surface-able functionality of the active application.

Another example one or more tangible processor-readable storage media are embodied with instructions for executing on one or more processors and circuits of a device a process of any preceding process where the generating operation further includes generating the prediction of one or more next functions based on past tracked user activity.

Another example one or more tangible processor-readable storage media are embodied with instructions for executing on one or more processors and circuits of a device a process of any preceding process where the one or more next functions are generated using machine learning.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method of predicting a next function in a set of associated application windows of a computing device having a contextual tool window, the method comprising:
tracking user activity in a set of associated application windows including one or more inactive application windows and an active application window executing an active application;
registering one or more surface-able functionalities of the active application and one or more user interfaces corresponding to the one or more surface-able functionalities;
generating a prediction of one or more next functions based on the tracked user activity in the set of associated application windows, the one or more next functions being functions of the active application executing in the active application window;
selecting the one or more predicted next functions from the one or more registered surface-able functionalities of the active application;
surfacing the one or more predicted next functions by presenting one or more controls from the one or more registered user interfaces corresponding to the one or more predicted next functions of the active application in the contextual tool window of the computing device, each control being capable of executing the corresponding predicted next function in the active application;
detecting user selection of a control of the one or more registered user interfaces of the one or more presented next functions in the contextual tool window, responsive to the surfacing operation; and
executing in the active application window the registered next function corresponding to the selected control of the one or more registered user interfaces, responsive to the detecting operation.

2. (canceled)

3. The method of claim 1, wherein registering the surface-able functionality of the active application comprises:
communicating the one or more registered surface-able functionalities of the active application and the one or more registered user interfaces corresponding to the one or more registered surface-able functionalities.

4. The method of claim 1, wherein the prediction of one or more next functions is predicted from the registered surface-able functionality of the active application.

5. The method of claim 1, wherein the prediction of one or more next functions is predicted further based on past tracked user activity.

6. The method of claim 1, wherein the one or more next functions are predicted using machine learning.

7. The method of claim 1, further comprising:
detecting user input to the control of the one or more presented next functions, responsive to detecting user selection of the control.

8. The method of claim 1, further comprising:
storing an identity of the selected control of the one or more presented next functions selected by the user, responsive to detecting user selection of the selected control.

9. A system for predicting a next function in a set of associated application windows of a computing device having a contextual tool window, the system comprising:
one or more processors;
a functionality surfacing datastore configured to register one or more surface-able functionalities of the active application and one or more user interfaces corresponding to the one or more surface-able functionalities;
a user activity tracker executed by the one or more processors and configured to track user activity in a set of associated application windows including one or more inactive application windows and an active application window executing an active application;
a next function predictor executed by the one or more processors and configured to generate a prediction of one or more next functions based on the tracked user activity in the set of associated application windows, the one or more next functions being functions of the active application executing in the active application window;
a functionality surfacer executed by the one or more processors and configured to select the one or more predicted next functions from the one or more registered surface-able functionalities of the active application and to surface the one or more next functions by presenting one or more controls from the one or more registered user interfaces corresponding to the one or more predicted next functions of the active application in the contextual tool window of the computing device, each control being capable of executing the corresponding predicted next function in the active application;
a contextual tool window control executed by the one or more processors and configured to detect user selection of a control of the one or more registered user interfaces of the one or more presented next functions in the contextual tool window, responsive to the surfacing of the one or more next functions; and
an associated windows synchronization service executed by the one or more processors and configured to execute in the active application window the registered next function corresponding to the selected control of the one or more registered user interfaces in the active application window, responsive to detection of the user selection.

10. (canceled)

11. The system of claim 9, wherein the functionality surfacing datastore is configured to register the one or more surface-able functionalities of the active application by receiving the one or more surface-able functionalities of the active application and the one or more user interfaces corresponding to the one or more surface-able functionalities.

12. The system of claim 9, wherein the next function predictor is further configured to generate the prediction of one or more next functions from the registered surface-able functionality of the active application.

13. The system of claim 9, wherein the next function predictor is further configured to generate the prediction of registered one or more next functions further based on past tracked user activity.

14. The system of claim 9, wherein the next function predictor is further configured to generate the prediction of one or more next functions using machine learning.

15. One or more tangible processor-readable storage media of a tangible article of manufacture encoding processor-executable instructions for executing on an electronic computing system a process of predicting a next function in a set of associated application windows of a computing device having a contextual tool window, the process comprising:
tracking user activity in a set of associated application windows including one or more inactive application windows and an active application window executing an active application;
registering one or more surface-able functionalities of the active application and one or more user interfaces corresponding to the one or more surface-able functionalities;
generating a prediction of one or more next functions based on the tracked user activity in the set of associated application windows, the one or more next functions being functions of the active application executing in the active application window;
selecting the one or more predicted next functions from the one or more registered surface-able functionalities of the active application;
surfacing the one or more predicted next functions by presenting one or more controls from the one or more registered user interfaces corresponding to the one or more predicted next functions of the active application in the contextual tool window of the computing device, each control being capable of executing the corresponding predicted next function in the active application;
detecting user selection of a control of the one or more registered user interfaces of the one or more presented next functions in the contextual tool window, responsive to the surfacing operation; and executing in the active application window the registered next function corresponding to the selected control of the one or more registered user interfaces in the active application window, responsive to the detecting operation.

16. (canceled)

17. The one or more tangible processor-readable storage media of claim 15 wherein the registering operation further comprises:
communicating the one or more surface-able functionalities of the active application and the one or more user interfaces corresponding to the one or more surface-able functionalities.

18. The one or more tangible processor-readable storage media of claim 15 wherein the prediction of one or more next functions is generated from the registered surface-able functionality of the active application.

19. The one or more tangible processor-readable storage media of claim 15 wherein the generating operation further comprises:
generating the prediction of one or more next functions based on past tracked user activity.

20. The one or more tangible processor-readable storage media of claim 15 wherein the one or more next functions are generated using machine learning.
